(19) United States
(12) Patent Application Publication
(10) Pub. No.: US 2007/0228961 A1
(43) Pub. Date: Oct. 4, 2007

(54) PLASMA DISPLAY PANEL

(75) Inventor: Ji Hoon SOHN, Gyeonggi-do (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/694,250

(22) Filed: Mar. 30, 2007

(30) Foreign Application Priority Data
Mar. 30, 2006 (KR) 10-2006-0028935

(51) Int. Cl. H01J 17/49

(52) U.S. Cl. 313/582

(57) ABSTRACT

A plasma display panel capable of achieving a reduction in the reflectance of the panel and an enhancement in contrast without a reduction in brightness is disclosed. The plasma display panel includes an upper substrate, a lower substrate arranged to face the upper substrate, and barrier ribs arranged between the upper substrate and the lower substrate to define a discharge cell space. Each barrier rib has at least a portion increasing in width toward the upper substrate.

This application claims the benefit of Korean Patent Application No. 10-2006-0028935, filed on Mar. 30, 2006, which is hereby incorporated by reference as if fully set forth herein.

### BACKGROUND OF THE INVENTION

1. Field of the Invention

The present invention relates to a plasma display panel, and more particularly to a plasma display panel with an enhancement in contrast.

2. Discussion of the Related Art

Plasma display panels are well known as an emissive device which displays an image using a discharge phenomenon. Such a plasma display panel (PDP) is being highlighted as a display for an image display device having a large screen because the PDP has many advantages of simple manufacture, large screen size, and rapid response speed in that it is unnecessary to provide active elements for respective cells.

As shown in FIG. 1, such a PDP has a structure in which an upper panel 10 and a lower panel 20 are assembled such that they face each other. The upper panel 10 includes a transparent substrate 11, and a pair of sustaining electrodes 12 arranged on an inner surface of the transparent substrate 11. Typically, the sustaining electrodes 12 are divided into a transparent electrode and a bus electrode.

The sustaining electrodes 12 are coated with a dielectric layer 13 for AC driving. A protection film 14 is formed over the dielectric layer 13.

On the other hand, the lower panel 20 includes a lower substrate 21, and address electrodes 22 arranged on an inner surface of the lower substrate 21. A dielectric layer 23 is formed over the address electrodes 22. Stripe or well type barrier ribs 24 are formed on the dielectric layer 23, to isolate discharge cells from one another. Red, blue, green phosphor layers 26 for color display are coated over the cells defined by the barrier ribs 24, to form sub-pixels.

The barrier ribs 24 define the discharge cells 25 for respective sub-pixels. A discharge gas is sealed in each discharge cell 25. Three different sub-pixels constitute one pixel.

In order to enhance the contrast of such a PDP, research has been conducted toward an enhancement in brightness and a reduction in reflectance. That is, it is necessary to display dark color in a further darkened state and to display bright color in a further brightened state.

In order to reduce the reflectance of such a panel, a scheme to form a black layer over the top surfaces of the barrier ribs 24 (namely, black top) or a scheme to form a black matrix (BM) on the upper panel 10 has been proposed.

However, the PDP has a structure in which the phosphor layers 26 exhibiting high reflectance are exposed to the eyes of the user through the transparent upper panel 10, as shown in FIG. 2. For this reason, it is considered that the phosphor layers 26 are the PDP portion having the greatest influence on the reflectance of the panel.

To this end, in order to reduce the reflectance of the PDP, research to reduce the reflectance of the phosphor layers 26 has been conducted. However, there is a limitation in achieving an enhancement in contrast because, when the aperture ratio corresponding to the exposure ratio of the phosphor layers is reduced, a reduction in brightness also occurs due to the structure of the PDP.

### SUMMARY OF THE INVENTION

Accordingly, the present invention is directed to a plasma display panel that substantially obviates one or more problems due to limitations and disadvantages of the related art.

An object of the present invention is to provide a plasma display panel in which barrier ribs are efficiently formed to reduce the reflectance of external light and to enhance the contrast of the panel.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a plasma display panel comprises: an upper substrate; a lower substrate arranged to face the upper substrate; and barrier ribs arranged between the upper substrate and the lower substrate to define a discharge cell space, each barrier rib having at least a portion increasing in width toward the upper substrate.

In another aspect of the present invention, a plasma display panel comprises: an upper substrate formed with a plurality of sustaining electrode pairs; a lower substrate arranged to face the upper substrate; and discharge cells defined between the upper substrate and the lower substrate by barrier ribs, each discharge cell having at least a portion increasing in width toward the upper substrate.

In another aspect of the present invention, a plasma display panel comprises: an upper panel including an upper substrate, and upper barrier ribs formed over the upper substrate, each barrier rib decreasing in width as the barrier rib extends away from the upper substrate; and a lower panel including lower barrier ribs respectively joined with the upper barrier ribs.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view illustrating an example of a general plasma display panel;

FIG. 2 is a sectional view illustrating the general plasma display panel;

FIG. 3 is a sectional view illustrating a plasma display panel according an exemplary embodiment of the present invention;

FIG. 4 is a sectional view illustrating a plasma display panel according to another embodiment of the present invention;

FIG. 5 is a sectional view illustrating the light extraction efficiency and reflectance reduction of the plasma display panel according to the present invention; and

FIG. 6 is a perspective view illustrating an example of a discharge cell space in the plasma display panel according to the present invention.

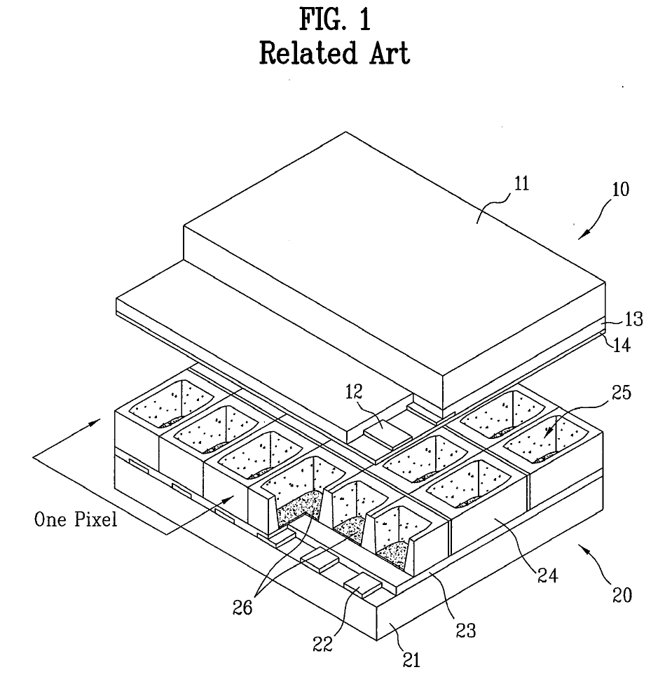

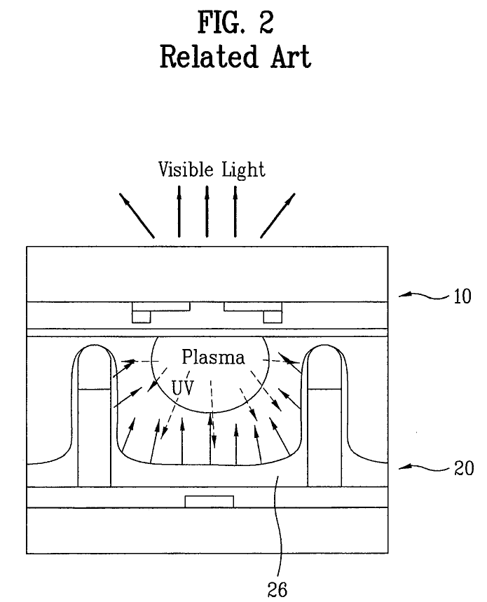

### DETAILED DESCRIPTION OF THE INVENTION

The present invention now will be described more fully hereinafter with reference to the accompanying figures, in which embodiments of the invention are shown.

This invention may, however, be embodied in many alternate forms and should not be construed as limited to the embodiments set forth herein. Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims.

Like numbers refer to like elements throughout the description of the figures. In the drawings, the thickness of layers and regions are exaggerated for clarity.

It will be understood that when an element such as a layer, region or substrate is referred to as being “on” another element, it can be directly on the other element or intervening elements may also be present. It will also be understood that if part of an element, such as a surface, is referred to as “inner,” it is farther to the outside of the device than other parts of the element.

In addition, relative terms, such as “beneath” and “overlies”, may be used herein to describe one layer's or region's relationship to another layer or region as illustrated in the figures.

It will be understood that these terms are intended to encompass different orientations of the device in addition to the orientation depicted in the figures. Finally, the term “directly” means that there are no intervening elements. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms.

These terms are only used to distinguish one region, layer or section from another region, layer or section. Thus, a first region, layer or section discussed below could be termed a second region, layer or section, and similarly, a second region, layer or section may be termed a first region, layer or section without departing from the teachings of the present invention.

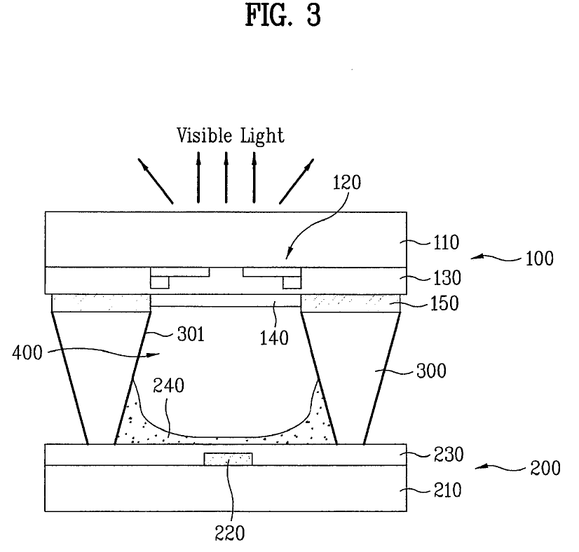

Referring to FIG. 3, a plasma display panel (PDP) according to en exemplary embodiment of the present invention is shown. As shown in FIG. 3, the PDP includes an upper panel 100, a lower panel 200, and barrier ribs 300 formed between the upper panel 100 and the lower panel 200 to define a discharge cell space 400. Each barrier rib 300 has a width increasing toward the upper substrate 100.

A black layer 150 may be arranged on the top of each barrier rib 300, to increase the contrast of the panel.

The upper panel 100 includes an upper substrate 110, a sustaining electrode pair 120 arranged on the upper substrate 110, and a first dielectric layer 130 covering the sustaining electrode pair 120.

A protection film 140 may be arranged between the adjacent black layers 150, to protect the upper panel 100 from high-frequency discharge occurring in the PDP.

On the other hand, the lower panel 200 includes a lower substrate 210, an address electrode 220 formed on the lower substrate 210, and a second dielectric layer 230 covering the address electrode 220.

Although the sustaining electrode pair 120 and address electrode 220 are illustrated as extending in parallel to each other, for the convenience of the illustration, they may practically be configured to extend orthogonally to each other.

The barrier ribs 300 are arranged on the second dielectric layer 230, to define the discharge cell space 400 as described above. Mirror surfaces 301 having a high reflectance are formed on the surfaces of the barrier ribs 300 defining the discharge cell space 400, in order to prevent a reduction in light extraction efficiency caused by the increased width of the barrier ribs 300.

Preferably, the reflectance of each mirror surface 301 is 50% or more. When the reflectance of each mirror surface is 70% or more, the above-described effect of the mirror surface is further increased.

The mirror surfaces 301, which are adapted to enable each barrier rib 300 to exhibit a high reflectance, may be formed through a mirror coating process for coating a metal having a high reflectance such as aluminum (Al) or silver (Ag) over the side walls of the barrier rib 300. Alternatively, the barrier rib 300 itself may be formed of a material having a high reflectance.

It may be possible to enable the barrier rib 300 to have a high reflectance by adding powder of a highly-reflective material such as aluminum (Al) or silver (Ag) to the material of the barrier rib 300. Preferably, the barrier rib 300 has a reflectance of 50% or more. However, even at a reflectance of less than 50%, the barrier rib 300 can exhibit a desired function by virtue of the characteristics thereof.

A phosphor layer 240 is formed in the discharge cell space 400 defined by the barrier rib 300. When the barrier ribs 300 have an increased width, the discharge cell space 400 has a structure with a width decreasing toward the top of the discharge cell space 400.

The width of each barrier rib 300 may be linearly increased, as shown in FIG. 3, or may be non-linearly increased in the form of a curve.

Preferably, the top of the discharge cell space 400 defined by the barrier ribs 300 has an area equal to or larger than the area of the sustaining electrode pair 120.

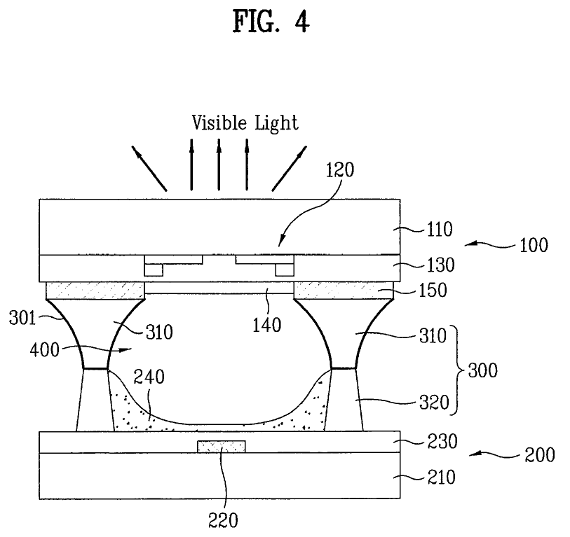

Meanwhile, as shown in FIG. 4, each barrier rib 300 may include a first barrier rib 310 having an increasing width, and a second barrier rib 320 having a typical barrier rib structure with a constant or finely decreasing width. The second barrier rib 320 is in contact with the first barrier rib 310.

A first space is defined by the width-increasing first barrier ribs 310 of the barrier ribs 300. Accordingly, the first space has a cross-sectional area decreasing toward the top of the first space. A second space is defined by the second barrier ribs 320 of the barrier ribs 300. Accordingly, the second space has a substantially constant cross-sectional area.

Preferably, the first barrier ribs 310 are formed on the upper panel 100, whereas the second barrier ribs 320 are formed on the lower panel 200. Subsequently, the first barrier ribs 310 and second barrier ribs 320 are joined. In this case, the first barrier ribs 310 may be referred to as “upper barrier ribs”, whereas the second barrier ribs 320 may be referred to as “lower barrier ribs”.

As shown in FIG. 4, each first barrier rib 310 having an increasing width may have a cross-sectional area increasing in the form of a curve, namely, in the form of a quadratic function. If necessary, the width of each first barrier rib 310 may increase linearly.

A phosphor layer 240 may be laminated in the space defined by the second barrier ribs 320. That is, although the phosphor layer 240 may be completely formed in the discharge cell space 400 defined by both the first barrier ribs 310 and the second barrier ribs 320, it may be formed only in the portion of the discharge cell space 400 defined by the second barrier ribs 320, as shown in FIG. 4.

The discharge cell space 400, which is defined by the first and second barrier ribs 310 and 320, has a cross-sectional area decreasing toward the top of the discharge cell space 400. In this case, it is possible to achieve an enhancement in light extraction efficiency by forming the mirror surfaces 301 on the surfaces of the first barrier ribs 310 or by forming the first barrier ribs 310 using a material having a high reflectance.

As in the case of FIG. 3, a black layer 150 is formed on each first barrier rib 310. Also, a first dielectric layer 130 is arranged between the adjacent black layers 150, and a protection film 140 may be formed on the first dielectric layer 130.

The first dielectric layer 130 covers sustaining electrode pair 120 arranged on the upper substrate 110.

That is, the first barrier ribs 310 may be formed on the first dielectric layer 130. The protection film 140 may be formed on the first dielectric layer 130 in a region where the first barrier ribs 310 are not arranged.

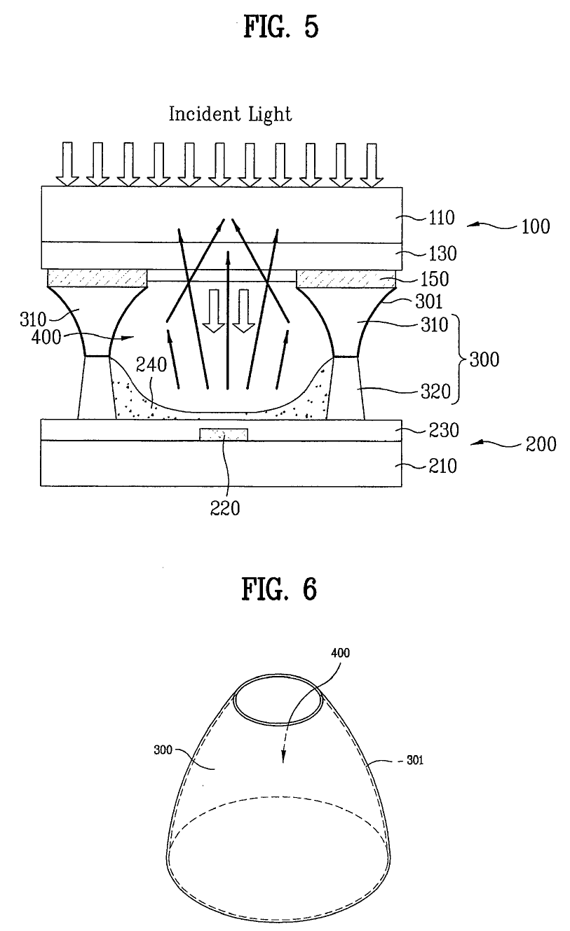

FIG. 5 schematically illustrates the anti-reflection and light extraction efficiency of the PDP which has the discharge cell space 400 with an area decreasing toward the top of the discharge cell space 400 in accordance with a width increase of the barrier ribs 300.

Since the discharge cell space 400 has a width decreasing toward the upper panel 100, the area of the highly-reflective portion exposed to the eyes of the user is decreased. Generally, the phosphor layer 240 exhibits white when no discharge occurs. Accordingly, the phosphor layer 240 is the portion reflecting external light.

Thus, light incident to the PDP through the upper panel 100 may degrade the contrast of the PDP because it is reflected by the phosphor layer 240. In accordance with the present invention, however, it is possible to achieve an enhancement in the contrast of the panel because the externally-exposed area of the highly-reflective portion is reduced.

In addition, the black layer 150 formed on the top of each barrier rib 300 can further enhance the contrast.

Light generated in the discharge cell space 400 is externally emitted after being reflected by the mirror surfaces 301. Accordingly, there is no reduction in brightness even though the discharge cell space 400 is reduced.

Although the discharge cell space 400 may have various structures in accordance with the shape of the barrier ribs 300, it is preferred that the discharge cell space 400 have an optical waveguide structure.

When the discharge cell space 400 has an optical waveguide structure, it is possible to extract incident light without loss even when the area of the light outlet is reduced.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A plasma display panel comprising:
an upper substrate;
a lower substrate arranged to face the upper substrate; and
barrier ribs arranged between the upper substrate and the lower substrate to define a discharge cell space, each barrier rib having at least a portion increasing in width toward the upper substrate.

2. The plasma display panel according to claim 1, wherein each barrier rib increases in width throughout an overall portion of the barrier rib.

3. The plasma display panel according to claim 1, wherein each barrier rib comprises:
a first barrier rib having a substantially constant width; and
a second barrier rib arranged over the first barrier rib, the second barrier rib increasing in width.

4. The plasma display panel according to claim 3, wherein the first barrier rib is formed at the lower substrate, and the second barrier rib is formed at the upper substrate.

5. The plasma display panel according to claim 3, further comprising:
a phosphor layer formed in a space defined by the first barrier rib.

6. The plasma display panel according to claim 1, further comprising:
a mirror coating formed on an outer surface of each barrier rib.

7. The plasma display panel according to claim 1, wherein each barrier rib is made of a material having a high reflectance.

8. The plasma display panel according to claim 1, wherein the width of each barrier rib increases linearly.

9. The plasma display panel according to claim 1, wherein the width of each barrier rib increases in the form of a curve.

10. The plasma display panel according to claim 1, further comprising:
a black layer arranged on an upper end surface of each barrier rib.

11. The plasma display panel according to claim 1, further comprising:
a protection film arranged on an inner surface of the upper panel between the barrier ribs.

12. A plasma display panel comprising:
an upper substrate formed with a plurality of sustaining electrode pairs;
a lower substrate arranged to face the upper substrate; and
discharge cells defined between the upper substrate and the lower substrate by barrier ribs, each discharge cell having at least a portion increasing in width toward the upper substrate.

13. The plasma display panel according to claim 12, wherein each discharge cell comprises:
a first space having a constant cross-sectional area; and
a second space having a cross-sectional area decreasing as the second space extends upwardly.

14. The plasma display panel according to claim 12, wherein each discharge cell space has a width equal to or larger than a width of each sustaining electrode pair at a top of the discharge cell space.

15. The plasma display panel according to claim 12, further comprising:
a mirror coating formed on a surface defining each discharge cell space.

16. The plasma display panel according to claim 12, wherein each discharge cell space has a horizontal cross-sectional area uniformly decreasing as the discharge cell space extends upwardly.

17. A plasma display panel comprising:
an upper panel including an upper substrate, and upper barrier ribs formed over the upper substrate, each barrier rib decreasing in width as the barrier rib extends away from the upper substrate; and
a lower panel including lower barrier ribs respectively joined with the upper barrier ribs.

18. The plasma display panel according to claim 17, wherein the upper barrier ribs are formed on a dielectric layer formed over the upper substrate.

19. The plasma display panel according to claim 18, further comprising:
a black layer arranged between each upper barrier rib and the dielectric layer.

20. The plasma display panel according to claim 17, wherein each upper barrier rib has an outer surface having a reflectance of 50% or more.
